(19) United States
(12) Patent Application Publication
(10) Pub. No.: US 2021/0078699 A1
(43) Pub. Date: Mar. 18, 2021

(54) INSERT FOR A BLADE OF A ROTARY-WING AIRCRAFT AND A BLADE OF ROTARY-WING AIRCRAFT

(71) Applicant: Bell Textron Inc., Fort Worth, TX (US)

(72) Inventors: Paul Branson Sherrill, Grapevine, TX (US); Robert Patrick Wardlaw, Keller, TX (US); Robert Alan Self, Fort Worth, TX (US)

(21) Appl. No.: 16/575,329

(22) Filed: Sep. 18, 2019

(51) Int. Cl. B64C 27/473; B64C 27/00; F01D 5/28; B29D 99/00

(52) U.S. Cl. CPC B64C 27/473; B29D 99/0025; F01D 5/282; B64C 27/008

(57) ABSTRACT

In an implementation, a rotor blade for a helicopter may include an outer layer. The outer layer may have a leading edge region and a trailing edge region and may define a cavity. The leading edge region may include a first shape at least partially corresponding with an airfoil, e.g., a wing. An insert may be included within the cavity and be encompassed thereby. The insert may include a shape that substantially corresponds with the first shape, e.g., the insert may substantially correspond with a leading edge of an airfoil. The insert may have a plurality of weight shot each of which may be surrounded by a binding agent.

### STATEMENT REGARDING FEDERALLY SPONSORED RESEARCH OR DEVELOPMENT

Not applicable.

### BACKGROUND

This section is intended to provide background information to facilitate an understanding of various technologies described herein. It should be understood that the statements in this section are not to be read as admissions of prior art.

Rotary wing aircraft and fixed wing aircraft are heavier-than-air vehicles that create lift and/or thrust using propellers or rotary wing blades. In rotary wing aircraft, rotary wing blades are substantially lightweight. Weights are included inside the rotary wing blade to provide inertia to the rotary wing blades. These weights are often made of lead or a lead-based material. Lead is a relatively flexible material that will conform to the bending and torsional stresses of a rotary wing blade. However, lead weights present environmental problems and are, therefore, undesirable.

### SUMMARY

Briefly, particular implementations of claimed subject matter may relate to an aircraft wing, such as a stationary wing utilized by a fixed-wing aircraft or a rotary-wing utilized by a helicopter or tiltrotor aircraft.

In an implementation, a method of fabricating a blade for a rotary wing aircraft blade may include inserting a plurality of weight pellets (alternatively referred to herein as “shot”, wherein the term “shot” may refer to a plurality of pellets, balls, slugs, etc. or a single pellet, ball, slug, etc.) into a mold, inserting a binding agent into the mold, and curing the binding agent substantially around the plurality of weight shot. One or more of the plurality of weight shot may have a density of at least about 0.6 pounds per cubic inch. One or more of the plurality of weight shot may be tungsten.

The binding agent may be one of a resin, an adhesive or a combination of an adhesive and a resin. A fiber may be added to the binding agent to increase the strength of the binding agent. A negative or positive pressure may be applied to the mold to aid in distribution of the binding agent within the mold. Alternating negative and positive pressures may be applied to the mold.

A further implementation is a method of fabricating or improving a rotary wing blade for a rotary wing aircraft, which may include removing the rotary wing blade from the rotary wing aircraft, inserting a plurality of weight shot into the rotary wing blade, inserting a binding agent into the rotary wing blade, and curing the binding agent substantially around the plurality of weight shot. One or more of the plurality of weight shot may be tungsten or may generally have a density of at least about 0.6 pounds per cubic inch.

A further implementation may be a blade for the rotary wing aircraft and may include an outer layer and an inertia weight. The outer layer may define a cavity. The inertia weight may be within the defined cavity and may have a plurality of weight shot and a binding agent substantially surrounding the plurality of weight shot. One or more of the plurality of weight shot may be tungsten or may generally have a density of at least about 0.6 pounds per cubic inch. The weight shot may be tungsten, depleted uranium, lead, iridium, bismuth, combinations thereof. Any two of the plurality of weight shot may have densities that are unique relative to each other.

The binding agent may have a density of less than about 0.06 pounds per cubic inch and may have a density of at least about 0.03 pounds per cubic inch. The binding agent may be a resin, an adhesive or a combination of a resin and an adhesive. A percentage-by-volume of the plurality of weight shot to the binding agent may be between about fifty percent and about seventy-four percent.

The blade may include a plurality of the inertia weights. A fiber spacer may separate each of the plurality of inertia weights from a neighboring inertia weight. The fiber spacer may also overwrap all of the plurality of the inertia weights.

### BRIEF DESCRIPTION OF THE DRAWINGS

The present technique(s) will be described further, by way of example, with reference to implementations thereof as illustrated in the accompanying drawings. It should be understood, however, that the accompanying drawings illustrate only the various implementations described herein and are not meant to limit the scope of various techniques, methods, systems, or apparatuses described herein.

FIG. 1 illustrates a rotary wing aircraft having multiple blades according to an example implementation described herein;

FIG. 2 illustrates a substantial portion of a blade of the rotary wing aircraft according to an example implementation described herein;

FIG. 3 illustrates a partial cross-section of the blade according to an example implementation described herein;

FIG. 4A illustrates a high density inertia weight insert according to an example implementation described herein;

FIG. 4B illustrates an implementation of the invention as a layup of a rotary wing blade;

FIG. 5 is a flow chart for a method of fabricating a blade for a rotary wing aircraft in accordance with an implementation described herein; and

FIG. 6 is a flow chart for a method of improving an existing blade for a rotary wing aircraft in accordance with an implementation described herein.

### DETAILED DESCRIPTION

Autorotation is a phenomenon in rotary wing aircraft that allows a helicopter to execute a safe landing even after a loss of engine power. Autorotation is possible due to the rotary wing blades (e.g., a main rotor) maintaining motion due to the inertia of rotary wing blades. To achieve a proper amount of inertia and for dynamic tuning, e.g., removing imbalance in a rotor system, which includes the blades, the mast, etc., the rotary wing blades should have a significant weight.

In the case of actual engine failure, a clutch mechanism (called a freewheeling unit) disengages the engine from the main rotor allowing the main rotor to rotate freely without resistance from the engine. A pilot adjusts the pitch of the helicopter so that an upward flow of air through the rotary wing blades will spin the main rotor at a particular amount of rotations per minute, which causes a buildup of potential energy in the blades. Upon nearing a safe landing surface, the pilot takes advantage of the potential energy in the blades to execute a safe landing.

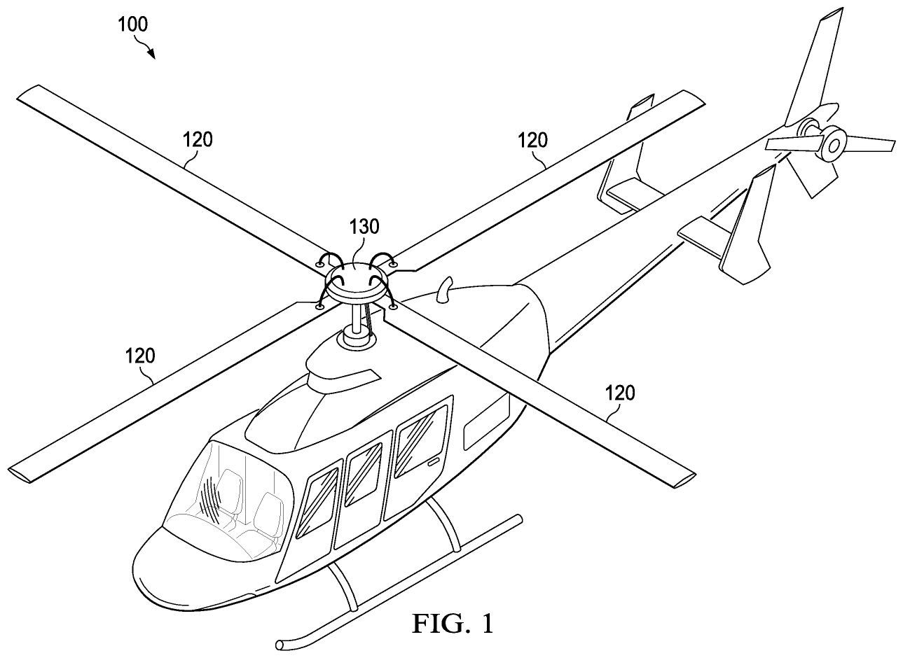

Particular implementations of claimed subject matter will now be described with reference to the figures, such as FIG. 1, which shows a representative aircraft 100. Although representative aircraft 100 shows a rotary-wing aircraft (e.g., a helicopter), implementations of claimed subject matter are not limited to applications of such aircraft types. Rather, claimed subject matter is intended to embrace a variety of aircraft environments, such as commercial or military aircraft utilizing one or more fixed wings, tiltrotor aircraft, commercial and military helicopters, and so forth. Additionally, although representative aircraft 100 is shown to include four rotary wing blades 120, implementations of claimed subject matter may be applied to a mast 130 of an a rotary wing aircraft and inclusive of any number of rotary wing blades 120, such as helicopters or tiltrotor aircraft including two blades, three blades, five blades, and so forth, virtually without limitation.

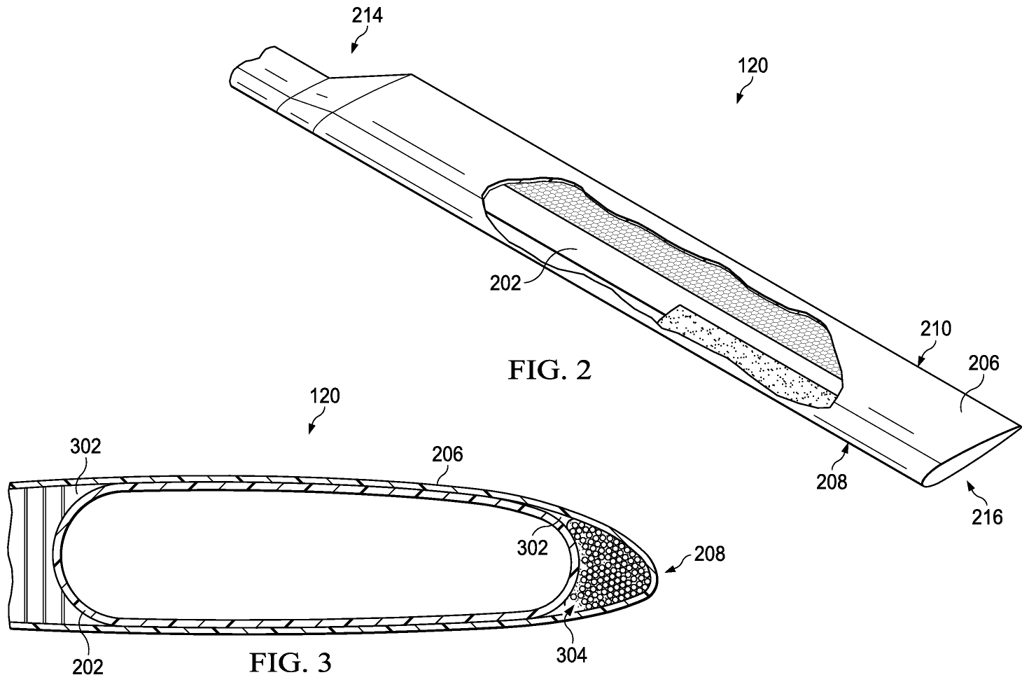

FIG. 2 illustrates an example implementation of a substantial portion of the blade 120 (alternatively referred to herein as, “rotary wing blade”). As illustrated, rotary wing blade 120 may include a rotary wing spar 202 and sheath 206 (e.g., an outer layer). The sheath 206 may include a leading edge region 208, a trailing edge region 210 and a cavity (which is discussed below).

Sheath 206 may be bonded or otherwise affixed to wing spar 202 so as to structurally cooperate with wing spar 202 in forming an airfoil, thus being capable of providing lift to a rotary- or fixed-wing aircraft, for example. The sheath 206 may be a thin sheet of material that is a few millimeters thick or it may be a thick layer of material having about an inch or two in thickness.

The wing spar 202 may be utilized to provide structural support for components of a rotary wing or for components of a fixed wing. As further illustrated in FIG. 2, the rotary wing blade 120 may further include root portion 214 and tip portion 216. In an implementation, such as that of a rotary-wing aircraft, root portion 214 may attach to the mast 130 of the helicopter 100 or may attach to a mast of a tiltrotor aircraft. In another implementation, such as that of a fixed-wing aircraft, root portion 214 may attach to an aircraft fuselage.

The wing spar 202 of the rotary wing blade 120 may include a hollow or solid metal shaft, which provides primary structural support for the remaining components of the rotary wing blade 120. In another implementation, rotary wing blade 120 may be comprised of one or more composite materials, such as carbon fiber. Although not shown in FIG. 2, the rotary wing blade 120 may be attached to other structural and/or control elements of a rotor system, such as a swashplate, pitch link, pitch horn, etc. The rotary wing blade 120 may make other connections and/or couplings to mechanical components of a rotary-wing aircraft, and claimed subject matter is not limited in this respect.

FIG. 3 illustrates a cross-section of the leading edge 208 of the rotary wing blade 120 in accordance with one implementation described herein. The rotary wing blade 120 may include a cavity 302. The cavity 302 may include an inertia weight 304 (alternatively referred to herein as a tuning weight). The inertia weight 304 may be heavier than the sheath 206, denser than the sheath 206, or both heavier and denser than the sheath 206.

The rotary wing blade 120 may include a single inertia weight 304 or multiple inertia weights 304. The inertia weight 304 (or plurality of inertia weights) may be in the tip portion 216 of the rotary wing blade 120. The tip portion 216 may be from about twenty to about thirty percent of the length of the blade on the opposite side of the rotary wing blade 120 from the root portion 214. The rotary wing blade 120, from the root portion 214 to the tip portion 216 of the rotary wing blade 120, may be subjected to bending moments that cause the rotary wing blade 120 to flex as a result of lift or other forces. If the rotary wing blade 120 includes a single inertia weight 304, the inertia weight 304 may be capable of flexing with the rotary wing blade 120.

Multiple inertia weights 304 may be used to account for flexing of the rotary wing blade 120. Thus, the weights do not each have to bend, e.g., flex, along with the rotary wing blade 120. The number of inertia weights 304, the size of the inertia weights 304 and the distance between each of the inertia weights 304 may depend on the amount of expected flex of the rotary wing blade 120.

Whether a single inertia weight 304 is used or whether multiple inertia weights are used, the rotary wing blade 120 may have a center of gravity (hereinafter referred to as “CG”) that is forward of the geometric center of the rotary wing blade 120 as opposed to aft of the geometric center of the rotary wing blade 120, thereby improving inertia of the rotary wing blade 120 in the forward direction. For example, as illustrated in FIG. 3, the inertia insert 304 is at the leading edge region 208 of the rotary wing blade 120.

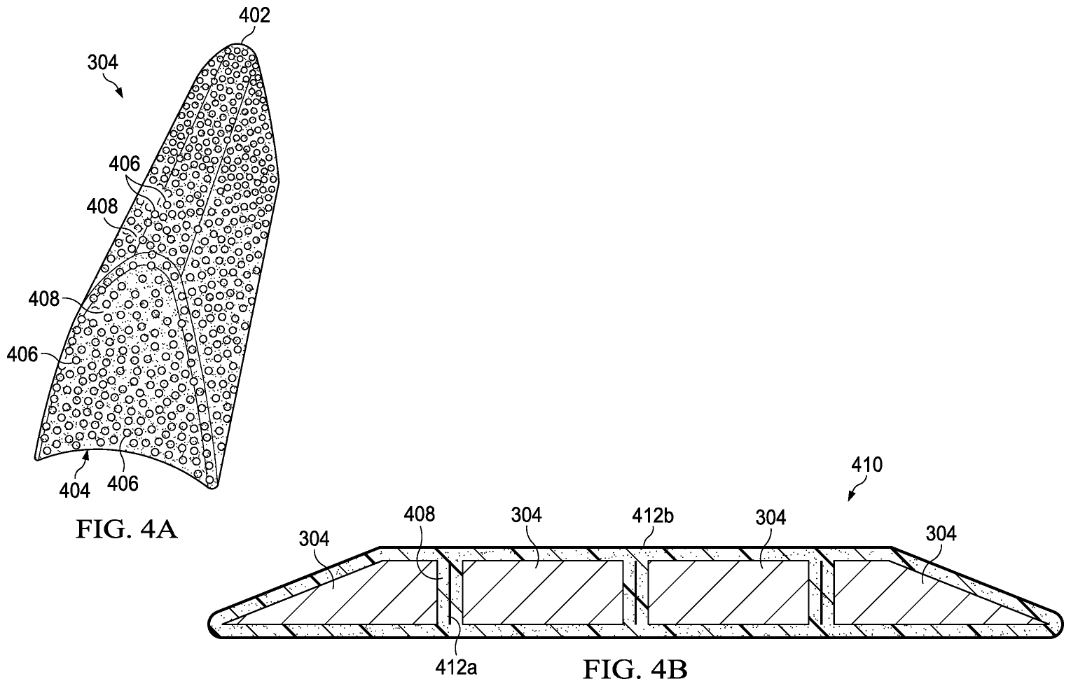

FIG. 4A illustrates an inertia weight 304 in accordance with one implementation described herein. The inertia weight 304 may be any shape or material. For example, the shape of the inertia weight 304 may be consistent with the leading edge of the rotary wing blade 120. Since the rotary wing blade 120 may have an air foil shape that has a cross-section in which the leading edge region 208 is curved and in which the trailing edge 206 is tapered, the inertia weight 304 may have a curved surface 402 that has a profile shaped similarly to that of the leading edge region 208 of the rotary wing blade 120. Thus, the curved surface 402 of the inertia weight 304 may snugly fit into and be encompassed by the leading edge region 208 of the rotary wing blade 120.

An opposing surface 404 of the inertia weight, e.g., the surface opposing the curved surface 402, may have any shape. For example, the opposing surface 404 may be planar, curved, irregular or tapered. The opposing surface 404 may be of a shape that pushes the CG toward the leading edge region 208 of the rotary wing blade 120 such as a crescent moon shape.

With further reference to FIG. 4A, the inertia weight may include at least two materials, one of which is suspended within the other. For example, the inertia weight 304 may include one or a plurality of weight shot 406. The plurality of weight shot 406 may be suspended within a composite resin material 408.

The plurality of weight shot 406 may be spherical and may be a maximum of about one quarter inch in diameter. Weight shot having a diameter of an eighth of an inch or smaller may also be used in any of the present implementations. The weight shot are not limited to spherical shapes but may have any shape. Any or all of the plurality of the weight shot may be spherical, partially spherical, cylindrical, pelletized, bearing-shaped, ball-shaped, polygonal, etc. The weight shot may all be substantially one size or may be different sizes.

The plurality of weight shot 406 may each have a dense material. For example, each of the plurality of weight shot 406 may be a material having a density of at least about 0.6 pounds per cubic inch. Tungsten, for example, has a density of about 0.615 lb/in³ (about 18 g/cm³).

An inertia weight including the weight shot 406, which may be made of a dense material, may reduce the amount of space within the blade necessary to house the inertia weight 304. Therefore, other components, e.g., strengthening webs or strengthening spars, electronics, etc., may be included in a location of the blade previously occupied by the inertia weight. An inertia weight having the plurality of weight shot 406 may provide a similar or improved performance of a lead-based inertia weight but may provide a faster manufacturing process than a lead-based weight, due at least in part to fewer materials being used.

The plurality of weight shot 406 within the inertia insert 304 may be about sixty-five percent of the volume of the inertia insert 304. The composite resin material 408 may account for substantially the remaining portion of the inertia insert 304.

An adhesive may be used to encapsulate the plurality of weight shot in place of the composite resin material. Any of the plurality of weight shot 406 that are on an exterior surface of the inertia insert 304 and, therefore, partially encapsulated by the adhesive are securely prevented from being unintentionally dislodged from the insert 304.

The material of each of the plurality of weight shot 406 may be any dense material such as tungsten, platinum, iridium, osmium, etc. Some high density materials are highly brittle and, therefore, may not be as beneficial in high bending moment environments such as in helicopter blades. Therefore, the inertia insert 304 may be designed to avoid fracture due to bending. For example, an inertia weight may be smaller than the blade so that it is one to two and a half percent the size of the blade. A blade that is twenty feet long (about six meters), for example, may have an inertia weight that is about six inches long (about 15 centimeters).

The composite resin material or adhesive may be elastic enough to accommodate bending of the blade. Thus, a longer inertia insert is possible while still avoiding failure due to bending stresses. A single inertia insert may be used since the composite resin material or adhesive may be elastic enough to allow the inertia insert to bend.

FIG. 4B illustrates a top plan view of a rotary wing blade layup 410 in accordance with an implementation described herein. As illustrated in FIG. 4B, multiple inertia weights may be placed in the rotary wing blade 120 and may have the same effect on the blade as a single inertia insert. FIG. 4B illustrates inertia inserts occupying an entire rotary wing blade. While this is possible, it is not necessary. The composite resin material 408 (and/or adhesive) may be between the inertia weights 304. In addition to advantages during manufacturing (discussed below), interior fiber spacers 412a may be added to the composite resin material (and/or adhesive) for strengthening and to provide added cushioning between inertia inserts thereby protecting more brittle materials, e.g., tungsten, from fracture. Fiber spacers 412b may be also added as an external overwrap around substantially the entirety of the rotary wing blade layup 410.

In any of the implementations described herein, the adhesive may be an epoxy film adhesive. The mold may be a shape of a rotary wing blade (or fixed wing blade) or some portion of a rotary wing blade (or fixed wing blade).

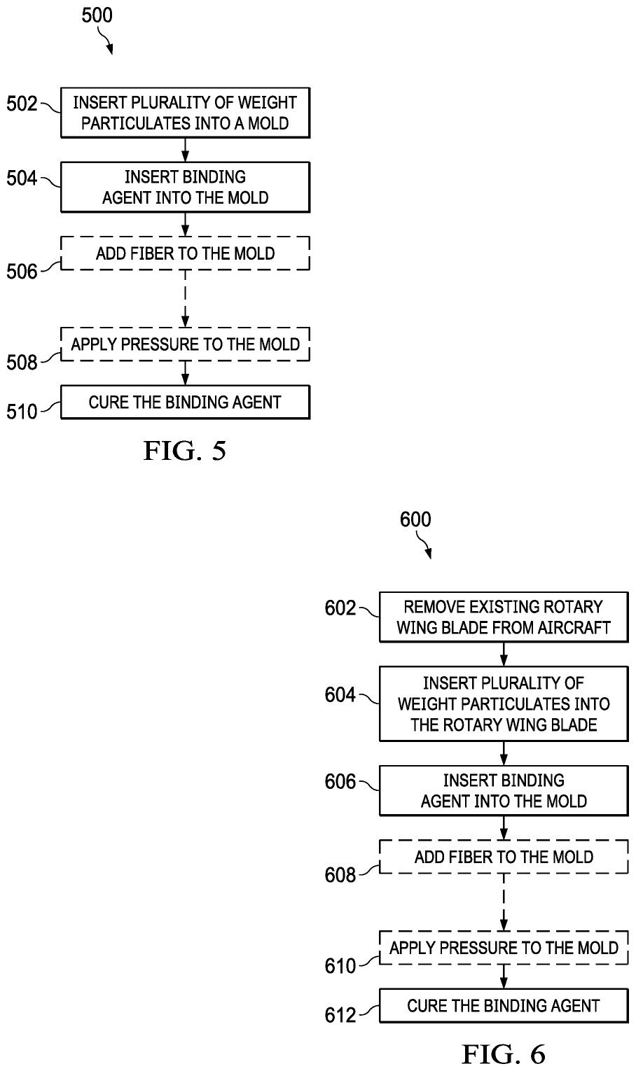

FIG. 5 is a flow chart 500 for a method of fabricating an aircraft blade according to an implementation described herein. FIG. 5 may include blocks in addition to those shown and described, fewer blocks or blocks occurring in an order different than may be identified, or any combination thereof. The method may begin at block 502, which may include inserting a plurality of weight shot into a mold. At step 504, a binding agent may also be inserted into the mold. At optional step 506, fiber may be added to the mold. The plurality of weight shot 406 may be distributed in the mold in any density. For example, the plurality of weight shot may be between about fifty percent and about seventy-four percent of the volume of the entire mold). At optional step 508, pressure may be applied to the mold. At step 510 the binding agent may be cured. Curing of the binding agent may be through a heat treatment. The binding agent such as, for example, a resin, may be created via a resin transfer molding (RTM) method, a same qualified resin transfer molding method (SQRTM) and/or a vacuum assisted resin transfer molding method (VARTM).

A further implementation of a method 600 of creating or improving an existing rotary wing is illustrated in FIG. 6. FIG. 6 may include blocks in addition to those shown and described, fewer blocks or blocks occurring in an order different than may be identified, or any combination thereof. The method 600 may begin at step 602 by removing the existing rotary wing blade from an aircraft. At step 604 a plurality of weight shot 406 may be inserted into the rotary wing blade. At step 606, a binding agent may be inserted into the removed rotary wing blade. At optional step 608, fiber may be added to the removed rotary wing blade. At optional step 610, pressure may be applied to the removed rotary wing blade. At step 612, the binding agent may be cured.

It is not necessary to hold the plurality of weight shot in any particular position within the composite before curing. For example, a vacuum molding process may be used to evenly disperse the plurality of weight shot within the composite resin material. Before or during inserting the plurality of weight shot, negative pressure, e.g., a vacuum, or positive pressure, e.g., a pump, may be applied to the mold. The applied pressure may urge the composite resin material or adhesive to flow around the plurality of weight shot before the composite resin material or adhesive cures. The composite resin material or adhesive may occupy the interstices between each of the plurality of weight shot and may provide a more even distribution of the plurality of weight shot within the resin or composite. To aid in the distribution of the resin or adhesive throughout the mold, the mold may be vibrated, e.g., jiggled, to move the resin or adhesive into the interstices between each of the plurality of weight shot.

Precision forming methods of the inertia insert 304 are unnecessary. Any imperfections of the inertia insert 304 may be negated by the resin or adhesive that coats each of the plurality of weight shot. As such, complex shapes are possible.

Although illustrative implementations of claimed subject matter have been described in detail herein with reference to the accompanying drawings, it is to be understood that the invention is not limited to those precise implementations, and that various changes, additions and modifications can be effected therein by one skilled in the art without departing from the scope of the invention as defined by the appended claims. For example, various combinations of the features of the dependent claims could be made with the features of the independent claims without departing from the scope of claimed subject matter.

Reference is made in this detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others.

Example implementations are provided so that this disclosure will be thorough, and will fully convey the scope to those who are skilled in the art. Numerous specific details are set forth such as examples of specific components, devices, and methods, to provide a thorough understanding of implementations of the present disclosure. It will be apparent to those skilled in the art that specific details need not be employed, that example implementations may be embodied in many different forms and that neither should be construed to limit the scope of the disclosure. In some example implementations, well-known processes, well-known device structures, and well-known technologies are not described in detail.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example implementations.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Further, it is to be understood that other implementations may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict the scope of claimed subject matter. Therefore, this detailed description is not to be taken to limit claimed subject matter and/or equivalents.

What is claimed is:

1. A method of fabricating an inertia insert for a rotary wing aircraft blade, comprising:
inserting a plurality of weight shot into a mold;
inserting a binding agent into the mold; and
curing the binding agent substantially around the plurality of weight shot.

2. The method of claim 1, wherein one or more of the plurality of weight shot is selected from the group consisting of one or more of tungsten, depleted uranium, lead, iridium, bismuth and combinations thereof.

3. The method of claim 1, wherein the binding agent is one of a resin, an adhesive or a combination of a resin and an adhesive.

4. The method of claim 3, further comprising:
adding a fiber to the binding agent.

5. The method of claim 1, further comprising:
applying a positive pressure to the mold.

6. The method of claim 1 further comprising:
applying a negative pressure to the mold.

7. The method of claim 1, wherein the mold is substantially shaped as an airfoil.

8. A method of improving a blade for a rotary wing aircraft, comprising:
removing the rotary wing blade from the rotary wing aircraft;
inserting a plurality of weight shot into the rotary wing blade;
inserting a binding agent into the rotary wing blade; and
curing the binding agent substantially around the plurality of weight shot.

9. The method of claim 8, wherein one or more of the plurality of weight shot is selected from the group consisting of one or more of tungsten, depleted uranium, lead, iridium, bismuth and combinations thereof.

10. The method of claim 8, wherein the binding agent is one of a resin, an adhesive or a combination of a resin and an adhesive.

11. The method of claim 10, further comprising:
adding a fiber to the binding agent.

12. The method of claim 8, further comprising:
applying a positive pressure to the mold.

13. The method of claim 8 further comprising:
applying a negative pressure into the mold.

14. A blade for a rotary wing aircraft, comprising:
an outer layer defining a cavity; and
an inertia weight within the defined cavity, the inertia weight having,
a plurality of weight shot; and
a binding agent substantially surrounding the plurality of weight shot.

15. The blade for a rotary wing aircraft as recited in claim 14, wherein one or more of the plurality of weight shot is selected from the group consisting of one or more of tungsten, depleted uranium, lead, iridium, bismuth, and combinations thereof.

16. The blade for a rotary wing aircraft as recited in claim 14, wherein the binding agent has a density of at least about 0.05 pounds per cubic inch.

17. The blade for a rotary wing aircraft as recited in claim 16, wherein the binding agent is one of a resin, an adhesive or a combination of a resin and an adhesive.

18. The blade for a rotary wing aircraft as recited in claim 16, wherein a percentage-by-volume of the weight shot to a total volume of the inertia weight is at least about fifty percent.
